(19) United States
(12) Patent Application Publication
(10) Pub. No.: US 2021/0213892 A1
(43) Pub. Date: Jul. 15, 2021

(54) METHOD FOR MANUFACTURING DECORATIVE LAYER OF VEHICLE INTERIOR TRIM AND VEHICLE INTERIOR TRIM

(71) Applicant: FAURECIA (CHINA) HOLDING CO., LTD., Shanghai (CN)

(72) Inventor: Jiadong ZHANG, Shanghai (CN)

(21) Appl. No.: 17/149,677

(22) Filed: Jan. 14, 2021

(30) Foreign Application Priority Data
Jan. 14, 2020 (CN) 202010037285.1

(51) Int. Cl. B60R 13/02; B29C 65/62; B29C 65/48; B29C 65/52; B29C 65/00

(52) U.S. Cl. CPC B60R 13/02; B29C 65/62; B29C 65/4815; B29L 2031/3041; B29C 66/02241; B29C 66/0242; B29C 65/526

(57) ABSTRACT

A method for manufacturing a vehicle interior trim decorative layer. The method includes: a die cutting step during which at least two parts to be sewn are die cut from a flat film, each of the at least two parts to be sewn having an outer surface and an inner surface opposite to the outer surface; a gluing step during which an adhesion agent is applied, by means of a roller coating machine, on the inner surface of each part to be sewn, and a sewing step during which all parts to be sewn are sewn together along a sewing line by means of a sewing machine so as to form a 3D shaped decorative layer. The decorative layer can be used with a substrate to form a vehicle interior trim. The method enables manufacturing of a 3D shaped decorative layer using a roller coating machine.

### FIELD OF THE INVENTION

The present invention relates to a method for manufacturing a decorative layer of a vehicle interior trim, and in particular, to the technical field of vehicle interior trims.

### BACKGROUND

A vehicle interior trim is an important component of a vehicle body, a workload of designing an interior trim system accounts for more than 60% of a workload of designing vehicle modeling far beyond that of designing a vehicle shape, and the interior trim system is one of the most important parts of the vehicle body. In recent years, consumers pay more attention to the aesthetic of an interior trim than vehicle shape designing, and characteristics such as touch, shape, and color of the vehicle interior trim have become one of major factors for consumers to purchase vehicles.

Therefore, major automobile enterprises also consider the vehicle interior trim as the focus of research and development and have tried various technical means to improve the vehicle interior trim. As an important auxiliary material necessary for automobile production, an adhesion agent can not only strengthen an automobile structure, perform fastening and rust-proof, and perform inside and outside decoration, but also replace a traditional process such as welding or riveting between some components, to implement connection between the same materials or different materials, thereby playing an increasingly important role in the development of automobiles toward light weight, high speed, energy saving, service life extension, and performance improvement. A water-based glue is the most widely used in the current vehicle market. However, there are many disadvantages in using the water-based glue. To ensure close adhesion of a decorative layer to a substrate, the water-based glue needs to be applied on both the decorative layer and the substrate by using a spraying process. When being sprayed, the adhesion agent is in an atomized state, and more than 50% of the adhesion agent is splashed out, and cannot effectively adhere to a set applying area, resulting in a huge waste of the adhesion agent. In addition, if moisture in the water-based glue is not completely removed, adhesion is greatly affected or even fails. Therefore, before adhesion, a splash-off operation needs to be further performed on moisture, and the process flow is relatively complex.

In recent years, to improve process efficiency and economic benefits, major automobile enterprises gradually select a hot-melt glue as an adhesion agent of the interior trim, since the hot-melt glue is characterized by environmental friendliness, non-toxicity, solvent-free, rapid curing, and the like, and is very suitable for automation and high-speed assembly line operations of the automotive industry. In addition, the hot-melt glue is characterized by energy saving, environmental friendliness, low smell, low VOC, and the like, and therefore meets the environment requirements of the automobile interior trim. However, currently, a conventional technical means is to glue a 3D shaped decorative layer in various ways. Because surfaces of the 3D shaped decorative layers are usually irregular, the difficulty and costs of gluing are increased. For example, a spraying machine, which is widely applied to the hot-melt glue process, is complex in structure and expensive. In addition, after long-term use of the spraying machine, a spraying head may be blocked, which severely affects gluing efficiency.

### SUMMARY

An objective of the present invention is to overcome one or more disadvantages found in the background art, that is, provide a method for manufacturing a decorative layer of a vehicle interior trim, to solve the technical problems that in the prior art, gluing efficiency and process costs are affected by a complex surface shape of a 3D shaped decorative layer, improve a process flow of a hot-melt glue in the aspect of vehicle interior trim application, and improve economic benefits.

To this end, the present invention provides a method for manufacturing a decorative layer of a vehicle interior trim, including at least the following steps:

a die cutting step during which a flat film is provided, and at least two parts to be sewn are die cut from the flat film, each of the at least two parts to be sewn having an outer surface and an inner surface opposite to the outer surface;

a gluing step during which an adhesion agent is applied, by means of a roller coating machine, on the inner surface of each part to be sewn; and

a sewing step during which all parts to be sewn are sewn together along a sewing line by means of a sewing machine so as to form a 3D shaped decorative layer.

According to at least some embodiments, after at least two parts to be sewn are die cut from a flat film for a decorative layer according to a predetermined shape of the decorative layer, an adhesion agent is applied, by means of a roller coating machine, on an inner surface of the part to be sewn, and then a sewing step is performed so as to form a 3D shaped decorative layer. An outer surface of the part to be sewn becomes a visible surface of the 3D shaped decorative layer, the inner surface of the part to be sewn is an invisible surface of the 3D shaped decorative layer, and the invisible surface is in contact with and adheres to an adherend. Since the gluing is performed on a plane, compared with a conventional technical means of applying an adhesion agent after the decorative layer is 3D shaped, the method greatly reduces complexity and process costs of a gluing process and improves economic benefits without affecting the aesthetic of an appearance of the decorative layer.

In addition, a hot-melt glue can be used as the adhesion agent. Compared with a water-based glue, solid content of the hot-melt glue is 100%, and a splash-off operation similar to that on the water-based glue is not required before adhesion, thereby greatly improving efficiency of the process flow.

The method may be carried out according to features of any of the following specific embodiments, either alone or in any technically-feasible combination.

In an embodiment, the method further includes a laminating step after the sewing step, during which a substrate is provided, and the decorative layer and the substrate are laminated together to form a covering.

In an embodiment, during the laminating step, the surface of the substrate is free of any adhesion agent. The adhesion agent also needs to be applied on the substrate when the water-based glue is used as the adhesion agent. However, because the hot-melt glue has the foregoing excellent performance, the laminating step can be easily completed by performing gluing only on the decorative layer. In addition, to avoid a case that the adhesion agent overflows from a gluing area to affect the aesthetic of an interior trim, part of the water-based glue further needs to be scraped off. According to the method, the amount of the used hot-melt glue is only about one-fourth of the amount of the water-based glue used in the conventional technical means, and consumption of the adhesion agent is greatly reduced, thereby reducing costs.

In an embodiment, the method further includes a heating step between the sewing step and the laminating step, during which the decorative layer is heated. A heating temperature needs to exceed an activation temperature of the adhesion agent, so that the hot-melt glue starts to soften, and an adhesion strength rises sharply, thereby implementing adhesion to an adherend.

In an embodiment, the laminating step is completed within a specific time after the end of the heating step, the specific time is less than an open time of the hot-melt glue, and a maximum open time of the hot-melt glue is four hours. As an adhesion strength of the hot-melt glue drops quickly after the open time, after the end of the heating step, the laminating step needs to be completed within the open time of the hot-melt glue, to avoid a case that the hot-melt glue loses viscosity to fail to implement adhesion of the decorative layer to an adherend.

In an embodiment, the sewing step includes cooling a sewing area. To avoid a case that the sewing area is affected by the heated and softened hot-melt glue to destroy the tightness of the sewing, the sewing area needs to be cooled at a room temperature before heating the hot-melt glue. Preferably, the temperature of the sewing area is lower than a softening point of the hot-melt glue, thereby preventing the tightness of the sewing area from being destroyed by the hot-melt glue.

In an embodiment, the sewing step includes blowing air to the head of the sewing machine, and a blowing direction is toward the edges of the parts to be sewn. An air-blowing operation ensures the flatness of a plane of the sewing area, so as to prevent unevenness of the sewing area that may occur during the sewing step, and also enhance a cooling effect of the sewing area, thereby lowering the temperature of the head of the sewing machine and the temperature of the sewing area to reduce impact of the hot-melt glue on the sewing area.

In an embodiment, during the gluing step, an adhesion layer is formed by the adhesion agent applied on the inner surface of each part to be sewn by means of the roller coating machine, and the adhesion layer has a thickness of 0.1 mm. In addition, to avoid a waste of the adhesion agent, the adhesion layer formed on the inner surface should not be excessively thick. To enable the decorative layer and the adherend to be fully bonded, the adhesion layer cannot be excessively thin, and preferably has a thickness of 0.1 mm

In an embodiment, the flat film is made of leather, leatherette, metal foil or fabric.

In conclusion, by using the method a plurality of problems such as excessively large consumption of the adhesion agent and a relatively complex gluing process that may exist in the existing technology of foam molding can be effectively solved.

Another aspect of the present invention further relates to a vehicle interior trim, including:

a substrate, and

a decorative layer, where the decorative layer includes at least two parts to be sewn, each of the at least two parts to be sewn has an outer surface and an inner surface opposite to the outer surface, an adhesion agent is applied on the inner surface of each part to be sewn, and these parts are sewn together after the adhesion agent is solidified so as to form the decorative layer;

where the decorative layer and the substrate are laminated together by heating the adhesion agent.

In an embodiment, the surface of the substrate is free of any adhesion agent.

In an embodiment, an adhesion agent of which the thickness is less than the thickness of the adhesion agent applied on each part to be sewn of the decorative layer is applied on the surface of the substrate.

In an embodiment, the adhesion agent is a hot-melt glue.

It should be understood that, in the present invention, except obviously contradictory cases or incompatible cases, all features, transformation ways and/or specific embodiments may be combined according to a plurality of combinations.

### BRIEF DESCRIPTION OF THE DRAWINGS

By reading the following specific embodiments as non-limiting descriptions with reference to the accompanying drawings, other features and advantages of the present invention will be apparent. In the drawings:

FIG. 1 is a flowchart of a method for manufacturing a decorative layer of a vehicle interior trim according to an embodiment of the present invention.

FIG. 2 is a flowchart of a method for manufacturing a decorative layer of a vehicle interior trim according to another embodiment of the present invention.

FIG. 3 is a schematic diagram of substeps of a sewing step according to an embodiment of the method.

### DETAILED DESCRIPTION

It should be understood that, the foregoing accompanying drawings are not in a substantial proportion, but merely simple drawings used to describe a plurality of preferred features of the basic principles of the present invention. Design features disclosed herein, such as a dimension, a direction, a location, and a shape, are determined by specific applications and using environments.

The present invention is described in detail with reference to embodiments and the accompanying drawings. In the accompanying drawings, the same reference number refers to the same or equivalent elements of the embodiments in all the accompanying drawings.

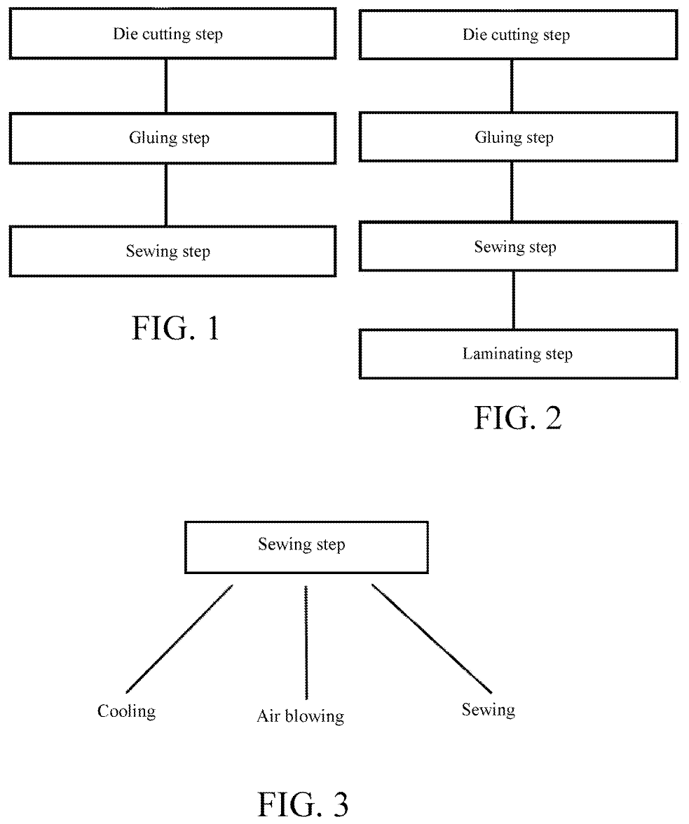

FIG. 1 shows a method for manufacturing a decorative layer of a vehicle interior trim. The method includes at least a die cutting step, a gluing step, and a sewing step. The following describes steps of the method according to the present invention in detail.

The die cutting step includes: providing a flat film, and die cutting at least two parts to be sewn from the flat film, where each of the at least two parts to be sewn has an outer surface and an inner surface opposite to the outer surface.

Specifically, according to the method, the die cutting means that the flat film for a decorative layer is cut, according to a pre-conceived 3D shape of the decorative layer, into plane shapes corresponding to the at least two parts to be sewn. It is necessary to ensure that the flat film that is cut into the at least two parts to be sewn can form the pre-conceived 3D shaped decorative layer in a manner of sewing.

The gluing step includes: applying, by means of a roller coating machine, an adhesion agent on the inner surface of each part to be sewn.

After the end of the die cutting, the outer surface of the part to be sewn is used as a visible surface of the 3D shaped decorative layer, and the inner surface of the part to be sewn is used as an invisible surface of the 3D shaped decorative layer. The adhesion agent is applied on the inner surface, so as to avoid affecting the aesthetic of an appearance of an interior trim due to a gluing process. To ensure that the decorative layer can be completely bonded to an adherend, the adhesion agent needs to be applied on each inner surface.

According to the method, the adhesion agent is preferably a hot-melt glue. Compared with a water-based glue, solid content of the hot-melt glue is 100%, and the hot-melt glue has a gap filling performance, thereby preventing disadvantages such as deformation, dislocation, and shrinkage of an adherend caused by curling, bubbling, and cracking at the edges of the gluing area. Because of being solvent-free, moisture content of wood does not change, and there is no danger of fire or poisoning. In addition, an adhesion speed of the hot-melt glue is relatively high, and a splash-off operation similar to that on the water-based glue is not required before adhesion, thereby greatly improving efficiency of the process flow.

Specifically, compared with a conventional machine component required to apply the hot-melt glue, for example, a spraying machine, the roller coating machine has significant advantages such as a simple structure, a convenient process flow, and low costs.

After the end of the gluing, an adhesion layer formed by the adhesion agent is formed on the inner surface. To avoid a waste of the adhesion agent, the adhesion layer formed on the inner surface should not be excessively thick. To enable the decorative layer and the adherend to be fully bonded, the adhesion layer cannot be excessively thin, and preferably has a thickness of 0.1 mm.

According to the method, the adhesion agent is directly applied on a plane by means of the roller coating machine. Compared with a conventional technical means of applying an adhesion agent after the decorative layer is 3D shaped, the method o greatly reduces complexity and process costs of a gluing process and improves economic benefits without affecting the aesthetic of an appearance of the decorative layer.

The sewing step includes: sewing all parts to be sewn together along a sewing line by means of a sewing machine so as to form a 3D shaped decorative layer.

Specifically, all parts to be sewn of the die cut flat film are sewn together correspondingly according to a pre-conceived 3D shaped decorative layer. In this case, the decorative layer has been 3D shaped, and the adhesion agent has been applied on an inner surface to be bonded to an adherend. Therefore, there is no need to perform a relatively complex conventional gluing operation on the 3D shaped decorative layer.

According to another embodiment of the present invention, the method may further include a laminating step after the sewing step. As shown in FIG. 2, the laminating step includes: providing a substrate, and laminating the decorative layer and the substrate together to form a covering.

To enhance the adhesion effect, preferably, the substrate is made of a material whose polarity attracts that of the hot-melt glue used in the method. Optionally, the material used for the substrate is further characterized by sparseness, so that the material is easily penetrated by a heated hot-melt glue. In addition, a surface temperature of the substrate needs to be controlled, and if the surface temperature is excessively low, wetting and penetration of the hot-melt glue are affected, and if the surface temperature is excessively high, a curing time is prolonged.

Preferably, the surface of the substrate is free of any adhesion agent.

Different from the process in which the adhesion agent also needs to be applied on the substrate when a water-based glue is used as the adhesion agent, because the hot-melt glue has the foregoing excellent performance, the laminating step can be easily completed by performing gluing only on the decorative layer. In addition, to avoid a case that the adhesion agent overflows from a gluing area to affect the aesthetic of an interior trim, part of the water-based glue further needs to be scraped off. According to the method, the amount of the used hot-melt glue is only about one-fourth of the amount of the water-based glue used in the conventional technical means, and consumption of the adhesion agent is greatly reduced, thereby reducing costs.

FIG. 3 is a schematic diagram of substeps of a sewing step according to the method. The sewing step includes at least: a sub step of cooling, a sub step of air blowing, and a sub step of sewing. The following specifically describes the substeps of cooling and air blowing in the sewing step.

The sewing step further includes: cooling a sewing area.

To avoid a case that the sewing area is affected by the heated and softened hot-melt glue to destroy the tightness of the sewing, the sewing area needs to be cooled at a room temperature before a heating step. Preferably, the temperature of the sewing area is lower than a softening point of the hot-melt glue, thereby preventing the tightness of the sewing area from being destroyed by the hot-melt glue.

The sewing step further includes: blowing air to the head of the sewing machine, and a blowing direction is toward the edges of the parts to be sewn.

An air-blowing operation ensures the flatness of a plane of the sewing area, so as to prevent unevenness of the sewing area that may occur during the sewing step, and also enhance a cooling effect of the sewing area, thereby further lowering the temperature of the head of the sewing machine and the temperature of the sewing area to reduce impact of the hot-melt glue on the sewing area, and maximally reduce the possible impact of the heated and softened hot-melt glue on the aesthetic of an appearance of the sewing area. Therefore, the method still maintains the aesthetic of an appearance of a vehicle interior trim while simplifying the process flow and improving economic benefits.

In addition, the method further includes a heating step (not shown), and the heating step includes: heating the decorative layer, especially the hot-melt glue on the decorative layer. The heating temperature needs to exceed an activation temperature of the adhesion agent without affecting a material of the decorative layer.

The heating step is between the sewing step and the laminating step. The hot-melt glue needs to be heated according to performance of the hot-melt glue, so that the hot-melt glue is gradually softened, and an adhesion strength rises sharply, thereby implementing adhesion to an adherend.

In addition, the laminating step needs to be completed within a specific time after the end of the heating step, the specific time is less than an open time of the hot-melt glue, and a maximum open time of the hot-melt glue is four hours.

The heated hot-melt glue has a very strong adhesion strength within a specific time. This period of time interval is referred to as an open time, and if the open time is missed, the hot-melt glue is solidified or crystallized, resulting in losing a capability of wetting a bonded object and failing to bond any component.

In the entire process flow, the open time of the hot-melt glue is settable, and different components of the hot-melt glue have different open times. The open time may be prolonged by increasing a glue melting temperature of a device. However, if the temperature of the hot-melt glue is excessively high and exceeds a melting point of the hot-melt glue, carbonization of the glue may occur, and quality in use of the hot-melt glue is severely affected. A larger glue outflow indicates slower cooling and a longer open time, and to avoid excessive consumption of the adhesion agent and unnecessary waste, the amount of the adhesion agent needs to be controlled in use. In addition, a lower environment temperature and a lower material temperature indicate faster cooling on the hot-melt glue, so that the open time is shortened. In conclusion, various factors need to be comprehensively controlled to achieve an expected open time.

The open time can directly affect an adhesion strength and a curing speed of the hot-melt glue. If the open time is excessively long, the adhesion strength of the hot-melt glue is remarkably reduced, and the curing speed is also reduced, not facilitating adhesion of the decorative layer. However, to perfectly complete the laminating step with a sufficient time, the open time should not be set too short. Preferably, the open time is set to four hours.

Preferably, the flat film is made of a conventional material used in the field of vehicle interior trims, and preferably made of leather, leatherette, metal foil or fabric, so that the decorative layer has a good touch.

Another aspect of the present invention further relates to a vehicle interior trim, including a substrate and a decorative layer. The decorative layer includes at least two parts to be sewn, each of the at least two parts to be sewn has an outer surface and an inner surface opposite to the outer surface. When the vehicle interior trim is mounted in a vehicle, the outer surface of each part to be sewn is a visible surface relative to a vehicle passenger, and the inner surface of each part to be sewn is an invisible surface relative to the vehicle passenger. An adhesion agent is applied on the inner surface of each part to be sewn and the parts are sewn together along a sewing line after the adhesion agent is solidified, to form a decorative layer. The decorative layer is especially in a 3D form after being sewn, for example, in a convex, concave, or folded form. Preferably, the sewing line is free of the adhesion agent.

The decorative layer and the substrate are laminated together by heating the adhesion agent. Especially, the decorative layer may be a decorative layer manufactured through any method described above. Optionally, the surface of the substrate is free of any adhesion agent, or an adhesion agent of which the thickness is less than the thickness of the adhesion agent applied on each part to be sewn of the decorative layer is applied on the surface of the substrate.

Specifically, the adhesion agent is a hot-melt glue, and is preferably applied by means of a roller coating machine.

The embodiments above are merely used as examples, and are not intended to limit the present invention. On this basis, a person skilled in the art can anticipate other embodiments that can achieve the same functions within the protection scope of the claims of the present invention.

A person skilled in the art masters a plurality of embodiments, transformations, and improvements. In particular, it should be clear that, except obviously contradictory cases or incompatible cases, all the foregoing features, transformation ways and/or specific embodiments of the present invention may be combined with each other. All these embodiments, transformations and improvements fall within the protection scope of the present invention.

1. A method for manufacturing a decorative layer of a vehicle interior trim, the method comprising:
a die cutting step during which a flat film is provided, and at least two parts to be sewn are die cut from the flat film, each of the at least two parts to be sewn having an outer surface and an inner surface opposite to the outer surface;
a gluing step during which an adhesion agent is applied, by means of a roller coating machine, on the inner surface of each part to be sewn; and
a sewing step during which all parts to be sewn are sewn together along a sewing line by means of a sewing machine so as to form a 3D shaped decorative layer.

2. The method according to claim 1, wherein during the gluing step, an adhesion layer is formed by the adhesion agent applied on the inner surface of each part to be sewn by means of the roller coating machine, and the adhesion layer has a thickness of 0.1 mm.

3. The method according to claim 1, wherein the flat film is made of leather, leatherette, metal foil or fabric.

4. The method according to claim 1, wherein the adhesion agent is a hot-melt glue.

5. The method according to claim 1, wherein the sewing step comprises cooling a sewing area to a room temperature.

6. The method according to claim 1, wherein the sewing step comprises blowing air to the head of the sewing machine, and a blowing direction is toward the edges of the parts to be sewn.

7. The method according to claim 1, wherein the method further comprises a laminating step after the sewing step, during which a substrate is provided, and the decorative layer and the substrate are laminated together to form a covering.

8. The method according to claim 7, wherein during the laminating step, the surface of the substrate is free of any adhesion agent.

9. The method according to claim 7, wherein the method further comprises a heating step between the sewing step and the laminating step, during which the decorative layer is heated at a heating temperature higher than an activation temperature of the adhesion agent.

10. The method according to claim 9, wherein the laminating step is completed within a specific time after the end of the heating step, and the specific time is less than 4 hours.

11. A vehicle interior trim, comprising:
a substrate, and
a decorative layer comprising at least two parts to be sewn, each of the at least two parts to be sewn having an outer surface and an inner surface opposite to the outer surface, an adhesion agent being applied on the inner surface of each part to be sewn, and these parts being sewn together after the adhesion agent is solidified so as to form the decorative layer;
wherein the decorative layer and the substrate are laminated together by the adhesion agent.

12. The vehicle interior trim according to claim 11, wherein the adhesion agent is a hot-melt glue.

13. The vehicle interior trim according to claim 11, wherein the surface of the substrate is free of any adhesion agent.

14. The vehicle interior trim according to claim 13, wherein the adhesion agent is a hot-melt glue.

15. The vehicle interior trim according to claim 11, wherein an adhesion agent of which the thickness is less than the thickness of the adhesion agent applied on each part to be sewn of the decorative layer is applied on the surface of the substrate.

16. The vehicle interior trim according to claim 15, wherein the adhesion agent is a hot-melt glue.
